(19) United States
(12) Patent Application Publication
(10) Pub. No.: US 2019/0338191 A1
(43) Pub. Date: Nov. 7, 2019

(54) LIQUID CRYSTAL COMPOSITION AND LIQUID CRYSTAL DISPLAY INCLUDING THE SAME

(71) Applicant: DAXIN MATERIALS CORP., Taichung City (TW)

(72) Inventors: Chih-Yuan Lo, Taichung City (TW); Chung-Hsien Wu, Taichung City (TW); Chen Wang, Taichung City (TW); Chun-Chih Wang, Taichung City (TW)

(21) Appl. No.: 16/403,146

(22) Filed: May 3, 2019

(30) Foreign Application Priority Data
May 7, 2018 (TW) 107115445

(51) Int. Cl. C09K 19/56; C09K 19/30; C09K 19/12

(52) U.S. Cl. CPC C09K 19/56; C09K 2019/0448; C09K 19/12; C09K 19/3003

(57) ABSTRACT

A liquid crystal composition includes at least one of a difunctional compound represented by Formula (1) defined herein and a difunctional compound represented by Formula (2) defined herein, and at least one of a monofunctional compound represented by Formula (3) defined herein and a monofunctional compound represented by Formula (4) defined herein.

### CROSS-REFERENCE TO RELATED APPLICATION

This application claims the benefit of the priority date of Taiwanese Patent Application No. 107115445, filed on May 7, 2018, the disclosure of which incorporated herein in its entirety by this reference.

### FIELD

The disclosure relates to a liquid crystal composition, and more particularly to a liquid crystal composition for a liquid crystal display without a liquid crystal alignment film. The liquid crystal composition can also be used for a liquid crystal display having a liquid crystal alignment film

### BACKGROUND

Liquid crystal displays have been gradually developed from those having small-sized liquid crystal panels (for example, clocks, watches, calculators, and the like) to those having large-sized liquid crystal panels (for example, liquid crystal televisions, commercial billboards, and the like). With the increasing demand for enlarging the size of the liquid crystal panels, various liquid crystal display modes have been developed, which include a twisted nematic (TN) mode, a super-twisted nematic (STN) mode, a vertical alignment (VA) mode using a thin film transistor (TFT), an in-plane switching (IPS) mode, and the like.

The liquid crystal compositions having a negative value of the dielectric anisotropy (Δε) are usually used for the VA mode liquid crystal displays, which are primarily used for liquid crystal televisions. In order to satisfy properties such as a low driving voltage, a fast response speed, a wide operating temperature range, and the like, the liquid crystal compositions are usually required to have a high absolute value of dielectric anisotropy (Δε), a low viscosity, and a high clearing point (Tₙᵢ). In addition, the value of the optical anisotropy (Δn) of the liquid crystal compositions is required to be adjusted according to a product value of the optical anisotropy (Δn) and a cell gap (d) along with the cell gap. When the liquid crystal displays are used for the liquid crystal televisions, a fast response speed of the liquid crystal compositions used in the liquid crystal displays is achieved by reducing a rotational viscosity (γ1) of the liquid crystal compositions.

A polymer sustained alignment (PSA) mode liquid crystal display component, which includes a polymer stabilized (PS) mode display component, has been developed. The process for preparing the PSA mode liquid crystal display component involves adding a minor amount of a polymerizable compound into a liquid crystal composition, introducing the liquid crystal composition added with the polymerizable compound into a liquid crystal cell, applying a voltage between electrodes and irradiating active energy rays to the liquid crystal composition so as to subject the polymerizable compound to polymerization. The PSA liquid crystal display component can provide proper pretilt angles in the divided pixels such that a contrast ratio can be increased by enhancing light transmittance, and a response speed can be increased by uniformizing the pretilt angles.

The PSA liquid crystal display component still includes vertical alignment films respectively provided to the substrates. In order to simplify the process, reduce the cost, and increase the yield for the PSA liquid crystal display component, the step of omitting the formation of the vertical alignment films (i.e., to prepare a liquid crystal display component without an alignment film) has been proposed. Although the liquid crystal display component without an alignment film may have an enhanced light transmittance, an increased contrast ratio, and a fast response speed, an uneven display problem may still occur. Therefore, there is a need for further research on the liquid crystal compound and the polymerizable compound used for a liquid crystal composition.

In the liquid crystal display component without an alignment film, the alignment of the liquid crystal molecules will be controlled by the polymerizable compound after polymerization. In order to fulfill the requirement of providing the liquid crystal molecules with uniform and stable alignment, the polymerizable compound is required to have a good stability after polymerization.

Therefore, it is still desirable to develop a polymerizable compound and a liquid crystal composition including the polymerizable compound for the liquid crystal display component without an alignment film, in order to meet the application requirement of the liquid crystal display.

### SUMMARY

Therefore, a first object of the disclosure is to provide a liquid crystal composition which is useful for a liquid crystal display without an alignment film.

A second object of the disclosure is to provide a liquid crystal display which includes the liquid crystal composition.

According to a first aspect of the disclosure, there is provided a liquid crystal composition which includes:

at least one difunctional compound selected from the group consisting of difunctional compounds represented by Formulae (1) and (2), and

at least one monofunctional compound selected from the group consisting of monofunctional compounds represented by Formulae (3) and (4),

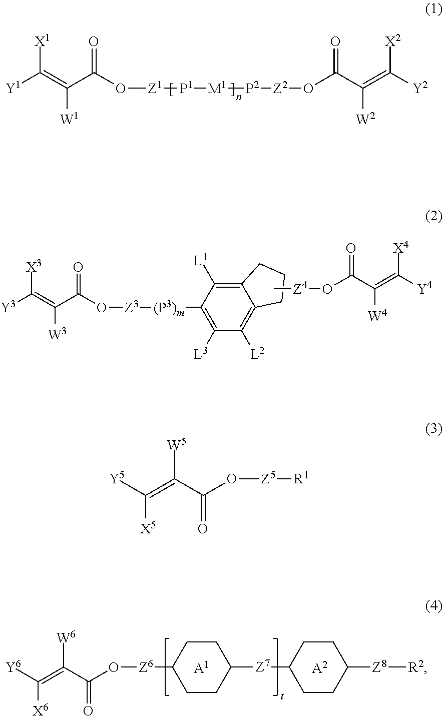

wherein

X¹ to X⁶, Y¹ to Y⁶, and W¹ to W⁶ each, independently of one another, represent hydrogen, hydroxyl, halogen, a C₁-C₁₅ straight alkyl group, a C₃-C₁₅ branched alkyl group, a C₂-C₁₅ straight alkenyl group, a C₃-C₁₅ branched alkenyl group, a C₂-C₁₅ straight alkynyl group, or a C₄-C₁₅ branched alkynyl group, wherein each of the C₁-C₁₅ straight alkyl group, the C₃-C₁₅ branched alkyl group, the C₂-C₁₅ straight alkenyl group, the C₃-C₁₅ branched alkenyl group, the C₂-C₁₅ straight alkynyl group, and the C₄-C₁₅ branched alkynyl group is unsubstituted or substituted with at least one radical selected from the group consisting of halogen and hydroxyl, and at least one —CH₂— group in each of the C₁-C₁₅ straight alkyl group, the C₃-C₁₅ branched alkyl group, the C₂-C₁₅ straight alkenyl group, the C₃-C₁₅ branched alkenyl group, the C₂-C₁₅ straight alkynyl group, and the C₄-C₁₅ branched alkynyl group is optionally replaced with a ring radical;

Z¹ to Z⁴ each, independently of one another, represent a single bond or a spacer group;

Z⁵ and Z⁶ each, independently of one another, represent a single bond, a C₁-C₁₅ straight alkylene group, a C₃-C₁₅ branched alkylene group, a C₂-C₁₅ straight alkenylene group, or a C₃-C₁₅ branched alkenylene group, wherein each of the C₁-C₁₅ straight alkylene group, the C₃-C₁₅ branched alkylene group, the C₂-C₁₅ straight alkenylene group, and the C₃-C₁₅ branched alkenylene group is unsubstituted or substituted with at least one halogen atom, and at least one —CH₂— group in each of the C₁-C₁₅ straight alkylene group, the C₃-C₁₅ branched alkylene group, the C₂-C₁₅ straight alkenylene group, and the C₃-C₁₅ branched alkenylene group is optionally replaced with a first divalent radical selected from the group consisting of —O—, —CO—, —COO—, and —OCO—, with the proviso that when at least two of the —CH₂— groups are replaced with the first divalent radicals, the first divalent radicals are not bonded to each other directly;

Z⁷ and Z⁸ each, independently of one another, represent a single bond, —COO—, —OCO—, —C≡C—, a C₁-C₁₂ straight alkylene group, a C₃-C₁₂ branched alkylene group, a C₂-C₁₂ straight alkenylene group, and a C₃-C₁₂ branched alkenylene group, wherein each of the C₁-C₁₂ straight alkylene group, the C₃-C₁₂ branched alkylene group, the C₂-C₁₂ straight alkenylene group, and the C₃-C₁₂ branched alkenylene group is unsubstituted or substituted with at least one halogen atom, and at least one —CH₂— group in each of the C₁-C₁₂ straight alkylene group, the C₃-C₁₂ branched alkylene group, the C₂-C₁₂ straight alkenylene group, and the C₃-C₁₂ branched alkenylene group is optionally replaced with a —O— radical, with the proviso that when at least two of the —CH₂— groups are replaced with the —O— radicals, the —O— radicals are not bonded to each other directly;

P¹ to P³, A¹, and A² each, independently of one another, represent 1,4-phenylene, 1,4-cyclohexylene, 1,4-cyclohexenylene, pyridine-2,5-diyl, pyrimidine-2,5-diyl, 1,3-dioxane-2,5-diyl, benzofuran-2,5-diyl, tetrahydropyran-2,5-diyl, a divalent trioxa-bicyclo[2.2.2]octyl functional group, a divalent dioxa-bicyclo[2.2.2]octyl functional group, or indane-2,5-diyl, each of which is unsubstituted or substituted with at least one radical selected from the group consisting of a C₁-C₈ alkyl group, a C₁-C₈ haloalkyl group, a C₁-C₈ alkoxyl group, halogen, a cyano group, and a nitro group;

M¹ represents —CH₂—, —C(CH₃)₂—, —C(CF₃)₂—, —SiH₂—, —Si(CH₃)₂—, or —Si(CF₃)₂—;

L¹ to L³ each, independently of one another, represent hydrogen, F, Cl, CN, a C₁-C₁₂ straight alkyl group, a C₃-C₁₂ branched alkyl group, a C₂-C₁₂ straight alkenyl group, a C₃-C₁₂ branched alkenyl group, a C₂-C₁₂ straight alkynyl group, or a C₄-C₁₂ branched alkynyl group, wherein each of the C₁-C₁₂ straight alkyl group, the C₃-C₁₂ branched alkyl group, the C₂-C₁₂ straight alkenyl group, the C₃-C₁₂ branched alkenyl group, the C₂-C₁₂ straight alkynyl group, and the C₄-C₁₂ branched alkynyl group is unsubstituted or substituted with at least one halogen atom, and at least one —CH₂— group in each of the C₁-C₁₂ straight alkyl group, the C₃-C₁₂ branched alkyl group, the C₂-C₁₂ straight alkenyl group, the C₃-C₁₂ branched alkenyl group, the C₂-C₁₂ straight alkynyl group, and the C₄-C₁₂ branched alkynyl group is optionally replaced with the first divalent radical selected from the group consisting of —O—, —CO—, —COO—, and —OCO—, with the proviso that when at least two of the —CH₂— groups are replaced with the first divalent radicals, the first divalent radicals are not bonded to each other directly;

R¹ and R² each, independently of one another, represent hydrogen, a C₁-C₇₀ straight alkyl group, a C₃-C₇₀ branched alkyl group, a C₂-C₇₀ straight alkenyl group, a C₃-C₇₀ branched alkenyl group, a C₂-C₇₀ straight alkynyl group, or a C₄-C₇₀ branched alkynyl group, wherein each of the C₁-C₇₀ straight alkyl group, the C₃-C₇₀ branched alkyl group, the C₂-C₇₀ straight alkenyl group, the C₃-C₇₀ branched alkenyl group, the C₂-C₇₀ straight alkynyl group, and the C₄-C₇₀ branched alkynyl group is unsubstituted or substituted with at least one halogen atom, and at least one —CH₂— group in each of the C₁-C₇₀ straight alkyl group, the C₃-C₇₀ branched alkyl group, the C₂-C₇₀ straight alkenyl group, the C₃-C₇₀ branched alkenyl group, the C₂-C₇₀ straight alkynyl group, and the C₄-C₇₀ branched alkynyl group is optionally replaced with the first divalent radical selected from the group consisting of —O—, —CO—, —COO—, and —OCO—, with the proviso that when at least two of the —CH₂— groups are replaced with the first divalent radicals, the first divalent radicals are not bonded to each other directly;

n is an integer ranging from 1 to 3, provided that when n is 2 or 3, a plurality of P¹s are the same or different and a plurality of M¹s are the same or different;

m is an integer ranging from 0 to 3, provided that when m is 2 or 3, a plurality of P³s are the same or different; and

t is an integer ranging from 1 to 2, provided that when t is 2, two A¹s are the same or different and two Z⁷s are the same or different.

According to a second aspect of the disclosure, there is provided a liquid crystal display, which includes the liquid crystal composition of the first aspect of the disclosure.

The liquid crystal composition of the disclosure includes a specific combination of the difunctional compound and the monofunctional compound defined herein, and thus exhibits an excellent vertical alignment and is suitable for a liquid crystal display without an alignment film.

### DETAILED DESCRIPTION

A liquid crystal composition according to the disclosure includes:

at least one difunctional compound selected from the group consisting of difunctional compounds represented by Formulae (1) and (2), and

at least one monofunctional compound selected from the group consisting of monofunctional compounds represented by Formulae (3) and (4),

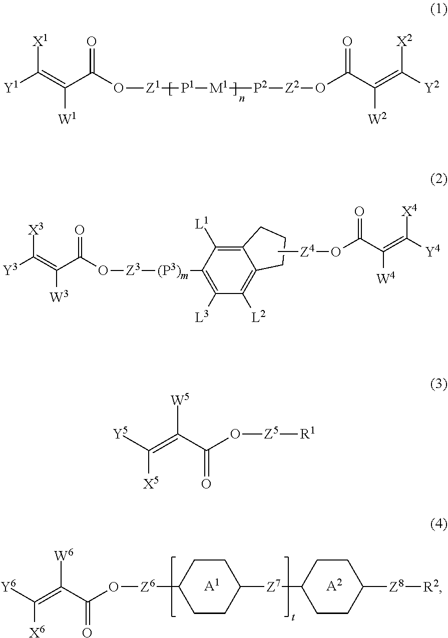

wherein

X¹ to X⁶, Y¹ to Y⁶, and W¹ to W⁶ each, independently of one another, represent hydrogen, hydroxyl, halogen, a C₁-C₁₅ straight alkyl group, a C₃-C₁₅ branched alkyl group, a C₂-C₁₅ straight alkenyl group, a C₃-C₁₅ branched alkenyl group, a C₂-C₁₅ straight alkynyl group, or a C₄-C₁₅ branched alkynyl group, wherein each of the C₁-C₁₅ straight alkyl group, the C₃-C₁₅ branched alkyl group, the C₂-C₁₅ straight alkenyl group, the C₃-C₁₅ branched alkenyl group, the C₂-C₁₅ straight alkynyl group, and the C₄-C₁₅ branched alkynyl group is unsubstituted or substituted with at least one radical selected from the group consisting of halogen and hydroxyl, and at least one —CH₂— group in each of the C₁-C₁₅ straight alkyl group, the C₃-C₁₅ branched alkyl group, the C₂-C₁₅ straight alkenyl group, the C₃-C₁₅ branched alkenyl group, the C₂-C₁₅ straight alkynyl group, and the C₄-C₁₅ branched alkynyl group is optionally replaced with a ring radical;

Z¹ to Z⁴ each, independently of one another, represent a single bond or a spacer group;

Z⁵ and Z⁶ each, independently of one another, represent a single bond, a C₁-C₁₅ straight alkylene group, a C₃-C₁₅ branched alkylene group, a C₂-C₁₅ straight alkenylene group, or a C₃-C₁₅ branched alkenylene group, wherein each of the C₁-C₁₅ straight alkylene group, the C₃-C₁₅ branched alkylene group, the C₂-C₁₅ straight alkenylene group, and the C₃-C₁₅ branched alkenylene group is unsubstituted or substituted with at least one halogen atom, and at least one —CH₂— group in each of the C₁-C₁₅ straight alkylene group, the C₃-C₁₅ branched alkylene group, the C₂-C₁₅ straight alkenylene group, and the C₃-C₁₅ branched alkenylene group is optionally replaced with a first divalent radical selected from the group consisting of —O—, —CO—, —COO—, and —OCO—, with the proviso that when at least two of the —CH₂— groups are replaced with the first divalent radicals, the first divalent radicals are not bonded to each other directly;

Z⁷ and Z⁸ each, independently of one another, represent a single bond, —COO—, —OCO—, —C≡C—, a C₁-C₁₂ straight alkylene group, a C₃-C₁₂ branched alkylene group, a C₂-C₁₂ straight alkenylene group, and a C₃-C₁₂ branched alkenylene group, wherein each of the C₁-C₁₂ straight alkylene group, the C₃-C₁₂ branched alkylene group, the C₂-C₁₂ straight alkenylene group, and the C₃-C₁₂ branched alkenylene group is unsubstituted or substituted with at least one halogen atom, and at least one —CH₂— group in each of the C₁-C₁₂ straight alkylene group, the C₃-C₁₂ branched alkylene group, the C₂— C₁₂ straight alkenylene group, and the C₃-C₁₂ branched alkenylene group is optionally replaced with a —O— radical, with the proviso that when at least two of the —CH₂— groups are replaced with the —O— radicals, the —O— radicals are not bonded to each other directly;

P¹ to P³, A¹, and A² each, independently of one another, represent 1,4-phenylene, 1,4-cyclohexylene, 1,4-cyclohexenylene, pyridine-2,5-diyl, pyrimidine-2,5-diyl, 1,3-dioxane-2,5-diyl, benzofuran-2,5-diyl, tetrahydropyran-2,5-diyl, a divalent trioxa-bicyclo[2.2.2]octyl functional group, a divalent dioxa-bicyclo[2.2.2]octyl functional group, or indane-2,5-diyl, each of which is unsubstituted or substituted with at least one radical selected from the group consisting of a C₁-C₈ alkyl group, a C₁-C₈ haloalkyl group, a C₁-C₈ alkoxyl group, halogen, a cyano group, and a nitro group;

M¹ represents —CH₂—, —C(CH₃)₂—, —C(CF₃)₂—, —SiH₂—, —Si(CH₃)₂—, or —Si(CF₃)₂—;

L¹ to L³ each, independently of one another, represent hydrogen, F, Cl, CN, a C₁-C₁₂ straight alkyl group, a C₃-C₁₂ branched alkyl group, a C₂-C₁₂ straight alkenyl group, a C₃-C₁₂ branched alkenyl group, a C₂-C₁₂ straight alkynyl group, or a C₄-C₁₂ branched alkynyl group, wherein each of the C₁-C₁₂ straight alkyl group, the C₃-C₁₂ branched alkyl group, the C₂-C₁₂ straight alkenyl group, the C₃-C₁₂ branched alkenyl group, the C₂-C₁₂ straight alkynyl group, and the C₄-C₁₂ branched alkynyl group is unsubstituted or substituted with at least one halogen atom, and at least one —CH₂— group in each of the C₁-C₁₂ straight alkyl group, the C₃-C₁₂ branched alkyl group, the C₂-C₁₂ straight alkenyl group, the C₃-C₁₂ branched alkenyl group, the C₂-C₁₂ straight alkynyl group, and the C₄-C₁₂ branched alkynyl group is optionally replaced with the first divalent radical selected from the group consisting of —O—, —CO—, —COO—, and —OCO—, with the proviso that when at least two of the —CH₂— groups are replaced with the first divalent radicals, the first divalent radicals are not bonded to each other directly;

R¹ and R² each, independently of one another, represent hydrogen, a C₁-C₇₀ straight alkyl group, a C₃-C₇₀ branched alkyl group, a C₂-C₇₀ straight alkenyl group, a C₃-C₇₀ branched alkenyl group, a C₂-C₇₀ straight alkynyl group, or a C₄-C₇₀ branched alkynyl group, wherein each of the C₁-C₇₀ straight alkyl group, the C₃-C₇₀ branched alkyl group, the C₂-C₇₀ straight alkenyl group, the C₃-C₇₀ branched alkenyl group, the C₂-C₇₀ straight alkynyl group, and the C₄-C₇₀ branched alkynyl group is unsubstituted or substituted with at least one halogen atom, and at least one —CH₂— group in each of the C₁-C₇₀ straight alkyl group, the C₃-C₇₀ branched alkyl group, the C₂-C₇₀ straight alkenyl group, the C₃-C₇₀ branched alkenyl group, the C₂-C₇₀ straight alkynyl group, and the C₄-C₇₀ branched alkynyl group is optionally replaced with the first divalent radical selected from the group consisting of —O—, —CO—, —COO—, and —OCO—, with the proviso that when at least two of the —CH₂— groups are replaced with the first divalent radicals, the first divalent radicals are not bonded to each other directly;

n is an integer ranging from 1 to 3, provided that when n is 2 or 3, a plurality of P¹s are the same or different and a plurality of M¹s are the same or different;

m is an integer ranging from 0 to 3, provided that when m is 2 or 3, a plurality of Pas are the same or different; and

t is an integer ranging from 1 to 2, provided that when t is 2, two A¹s are the same or different and two Z⁷s are the same or different.

The term “difunctional compound” as used herein indicates a compound having two terminal acrylate groups or two terminal acrylate-derived groups. Similarly, the term “monofunctional compound” as used herein indicates a compound having one terminal acrylate group or one terminal acrylate-derived group. The term “acrylate-derived group” as used herein indicates an acrylate group having at least one substituent at position 1 or position 2 thereof, and examples thereof include, but are not limited to,

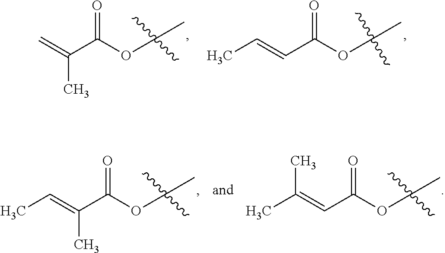

The term “spacer group” as used herein is a group for bonding a mesogenic group of a mesogenic compound to a polymerizable group of a polymerizable compound, and the details thereof may be found in, for example, Pure Appl. Chem. 73 (5), 888 (2001), C. Tschierske, G. Pelzl, S. Diele, Angew. Chem. 2004, 116, 6340-6368, and the like. Unless defined otherwise, examples of the spacer group, include, but are not limited to, —O—, —COO—, —OCO—, —C≡C—, —S—, —N—, a straight or branched alkylene group, a straight or branched alkenylene group, a straight or branched alkynylene group, and combinations thereof.

The term “pyridine-2,5-diyl” as used herein includes

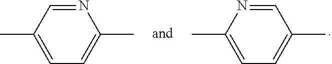

The term “pyrimidine-2,5-diyl” as used herein includes

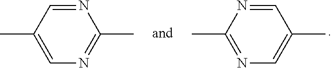

The term “benzofuran-2,5-diyl” as used herein includes

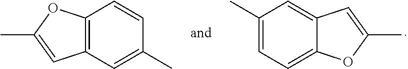

The term “1,3-dioxane-2,5-diyl” as used herein includes

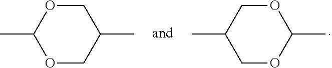

The term “tetrahydropyran-2,5-diyl” as used herein includes

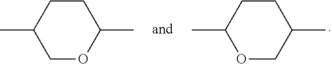

The term “divalent dioxa-bicyclo[2.2.2]octyl functional group” as used herein includes

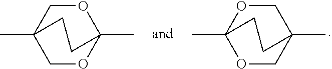

The term “divalenttrioxa-bicyclo[2.2.2]octylfunctionalgroup” as used herein includes

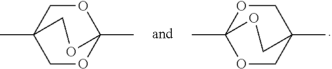

The term “indane-2,5-diyl” as used herein includes

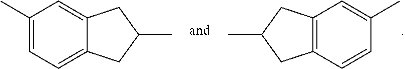

### Difunctional Compound:

The difunctional compound is selected from the group consisting of the difunctional compound represented by Formula (1) and the difunctional compound represented by Formula (2) as defined above.

In certain embodiments, the difunctional compound represented by Formula (1) is a difunctional compound represented by Formula (1a),

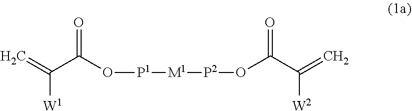

wherein

P¹ and P² each, independently of one another, represent 1,4-phenylene, 1,4-cyclohexylene, 3-fluoro-1,4-phenylene, 3,5-difluoro-1,4-phenylene, 2,3-difluoro-1,4-phenylene, 3-methyl-1,4-phenylene, 3,5-dimethyl-1,4-phenylene, or 2,3-dimethyl-1,4-phenylene; and

M¹, W¹, and W² are as defined above for Formula (1).

The difunctional compound represented by Formula (1a) can be prepared by any methods well known in the art, for example, according to a reaction scheme shown below.

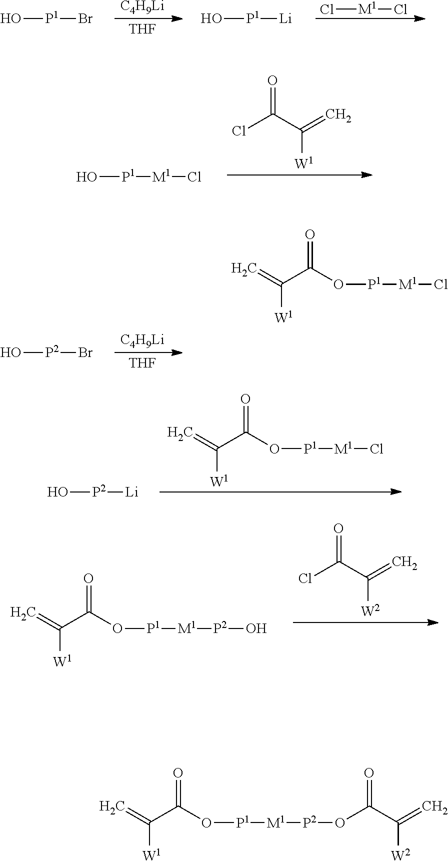

wherein P¹, P², W¹, W², and M¹ are as defined above.

In certain embodiments, both P¹ and P² in Formula (1a) are 1,4-phenylene, i.e., the difunctional compound represented by Formula (1a) is a difunctional compound represented by:

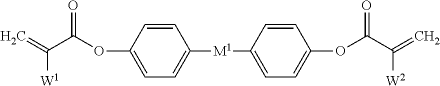

wherein W¹, W², and M¹ are as defined above.

In certain embodiments, P¹ and P² in Formula (1a) are 1,4-phenylene and 3-fluoro-1,4-phenylene, i.e., the difunctional compound represented by Formula (1a) is a difunctional compound represented by:

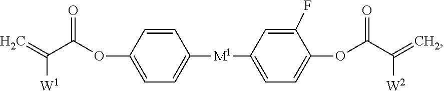

wherein W¹, W², and M¹ are as defined above.

The difunctional compound represented by Formula (1a) used in the following illustrated examples includes difunctional compounds represented by Formulae (1a-1), (1a-2), (1a-3), (1a-4), and (1a-5),

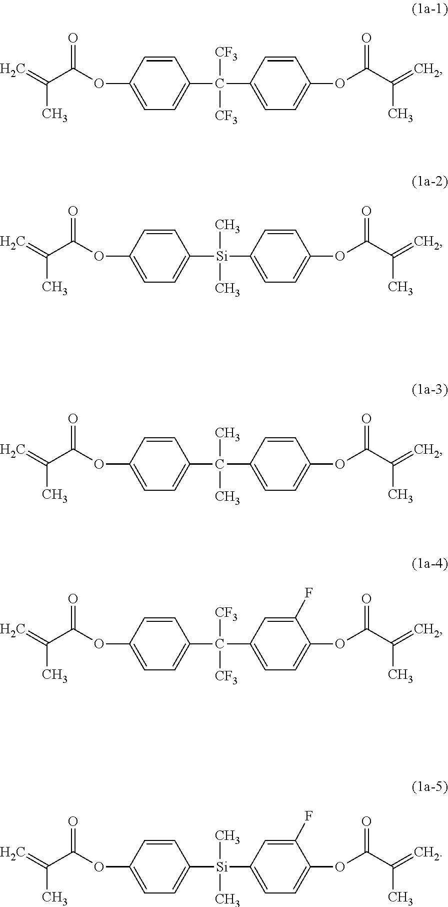 [SMILES: C=C(C)C(=O)Oc1ccc(C(c2ccc(OC(=O)C(=C)C)cc2)(C(F)(F)F)C(F)(F)F)cc1 ; C=C(C)C(=O)Oc1ccc([Si](C)(C)c2ccc(OC(=O)C(=C)C)cc2)cc1 ; C=C(C)C(=O)Oc1ccc(C(C)(C)c2ccc(OC(=O)C(=C)C)cc2)cc1 ; C=C(C)C(=O)Oc1ccc(C(c2ccc(OC(=O)C(=C)C)c(F)c2)(C(F)(F)F)C(F)(F)F)cc1 ; C=C(C)C(=O)Oc1ccc([Si](C)(C)c2ccc(OC(=O)C(=C)C)c(F)c2)cc1]

In certain embodiments, the difunctional compound represented by Formula (2) is a difunctional compound represented by Formula (2a),

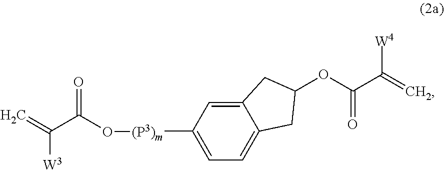

wherein

P³ represents 1,4-phenylene, 1,4-cyclohexylene, 3-fluoro-1,4-phenylene, 3,5-difluoro-1,4-phenylene, 2,3-difluoro-1,4-phenylene, 3-methyl-1,4-phenylene, 3,5-dimethyl-1,4-phenylene, or 2,3-dimethyl-1,4-phenylene; and

m, W³, and W⁴ are as defined above for Formula (2).

In certain embodiments, in Formula (2a), m is 2, and the two P³s represent 1,4-phenylene and 3-fluoro-1,4-phenylen, respectively, i.e., the difunctional compound represented by Formula (2a) is a difunctional compound represented by:

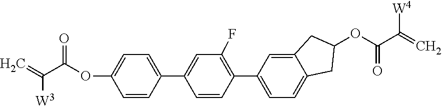

wherein W³ and W⁴ are as defined above.

In certain embodiments, in Formula (2a), m is 1, and both P³s are 1,4-phenylene, i.e., the difunctional compound represented by Formula (2a) is a difunctional compound represented by:

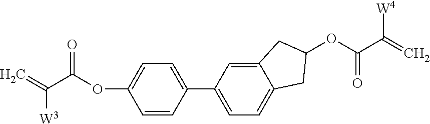

wherein W³ and W⁴ are as defined above.

The difunctional compound represented by Formula (1a) used in the following illustrated examples includes difunctional compounds represented by Formulae (2a-1) and (2a-2),

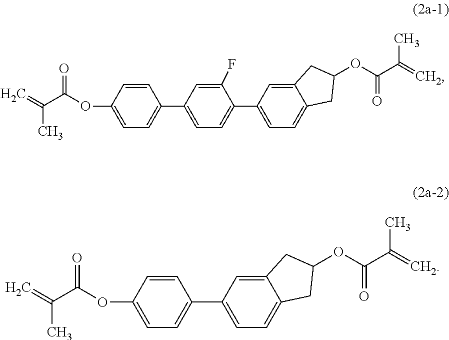 [SMILES: C=C(C)C(=O)Oc1ccc(-c2ccc(-c3ccc4c(c3)CC(OC(=O)C(=C)C)C4)c(F)c2)cc1 ; C=C(C)C(=O)Oc1ccc(-c2ccc3c(c2)CC(OC(=O)C(=C)C)C3)cc1]

Monofunctional Compound:

The monofunctional compound is selected from the group consisting of the monofunctional compound represented by Formula (3) and the monofunctional compound represented by Formula (4) as defined above.

In certain embodiments, the monofunctional compound represented by Formula (3) is a monofunctional compound represented by Formula (3a),

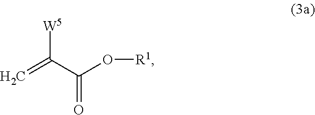

wherein

R¹ represents a C₁-C₃₀ straight alkyl group, a C₃-C₃₀ branched alkyl group, a C₂-C₃₀ straight alkenyl group, or a C₃-C₃₀ branched alkenyl group; and

W⁵ is as defined above for Formula (3).

The monofunctional compound represented by Formula (3a) used in the following illustrated examples includes monofunctional compounds represented by Formulae (3a-1), (3a-2), (3a-3), (3a-4), and (3a-5),

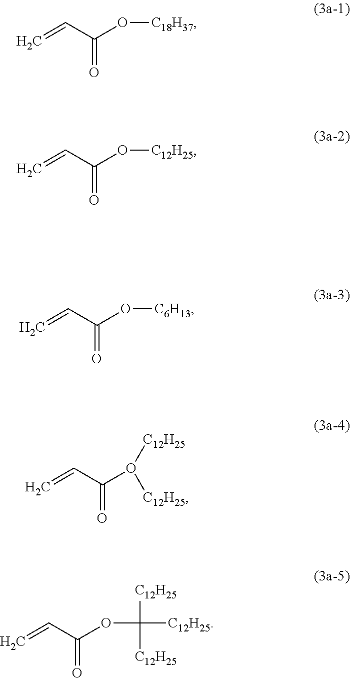

In certain embodiments, the monofunctional compound represented by Formula (4) is a monofunctional compound represented by Formula (4a),

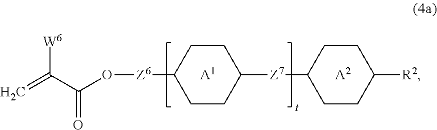

wherein

A¹ and A² each, independently of one another, represent 1,4-phenylene, 1,4-cyclohexylene, 3-fluoro-1,4-phenylene, 3,5-difluoro-1,4-phenylene, 2,3-difluoro-1,4-phenylene, 3-methyl-1,4-phenylene, 3,5-dimethyl-1,4-phenylene, or 2,3-dimethyl-1,4-phenylene;

Z⁷ represents a single bond, —COO—, —OCO—, —C≡C—, a C₁-C₆ straight alkylene group, or a C₃-C₆ branched alkylene group; and

W⁶, Z⁶, and R² are as defined above for Formula (4).

In certain embodiments, in Formula (4a), t is 1, ring A¹ represents 1,4-phenylene, Z⁷ represents a single bond, and ring A² represents 1,4-cyclohexylene, i.e., the monofunctional compound represented by Formula (4a) is a monofunctional compound represented by:

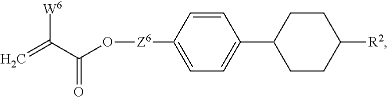

wherein W⁶, Z⁶, and R² are as defined above.

In certain embodiments, in Formula (4a), t is 1, ring A¹ represents 1,4-cyclohexylene, Z⁷ represents a single bond, and ring A² represents 1,4-cyclohexylene, i.e., the monofunctional compound represented by Formula (4a) is a monofunctional compound represented by:

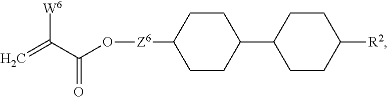

wherein W⁶, Z⁶, and R² are as defined above.

In certain embodiments, in Formula (4a), t is 2, each ring A¹ represents 1,4-phenylene, two Z⁷s represent —COO— and a single bond, respectively, and ring A² represents 1,4-cyclohexylene, i.e., the monofunctional compound represented by Formula (4a) is a monofunctional compound represented by:

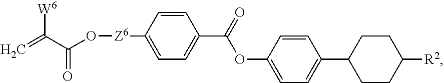

wherein W⁶, Z⁶, and R² are as defined above.

In certain embodiments, in Formula (4a), t is 2, each ring A¹ represents 1,4-phenylene, two Z⁷s represent —CF₂O— and a single bond, respectively, and ring A² represents 1,4-cyclohexylene, i.e., the monofunctional compound represented by Formula (4a) is a monofunctional compound represented by:

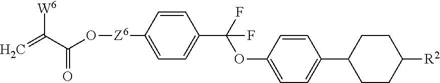

wherein W⁶, Z⁶, and R² are as defined above.

In certain embodiments, in Formula (4a), t is 2, each ring A¹ represents 1,4-phenylene, two Z⁷s represent —CH₂O— and a single bond, respectively, and ring A² represents 1,4-cyclohexylene, i.e., the monofunctional compound represented by Formula (4a) is a monofunctional compound represented by:

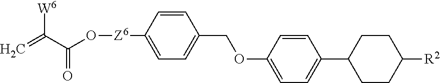

wherein W⁶, Z⁶, and R² are as defined above.

In certain embodiments, in Formula (4a), t is 2, each ring A¹ represents 1,4-phenylene, two Z⁷s represent —CH₂CH₂— and a single bond, respectively, and ring A² represents 1,4-cyclohexylene, i.e., the monofunctional compound represented by Formula (4a) is a monofunctional compound represented by:

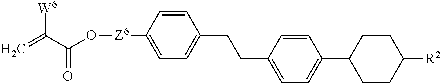

wherein W⁶, Z⁶, and R² are as defined above.

The monofunctional compound represented by Formula (4a) used in the following illustrated examples includes monofunctional compounds represented by Formulae (4a-1), (4a-2), (4a-3), (4a-4), (4a-5), (4a-6), and (4a-7),

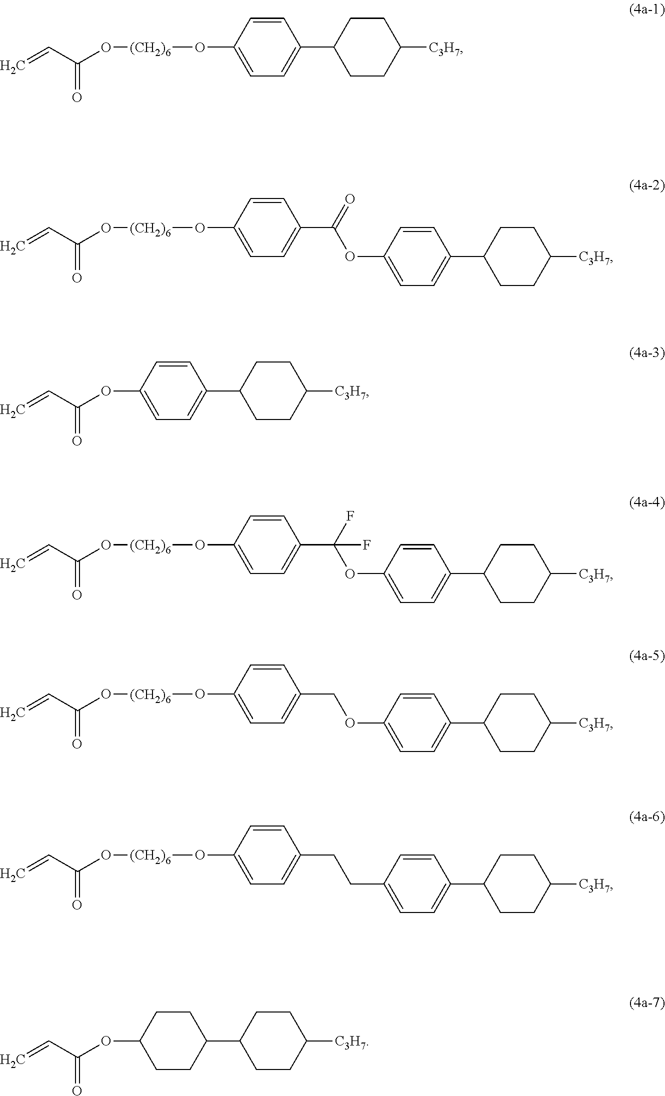

### Liquid Crystal Composition:

In the liquid crystal composition according to the disclosure, an amount of the at least one difunctional compound and that of the at least one monofunctional compound can be adjusted depending on specific requirements of the liquid crystal displays and/or properties of other liquid crystal compounds optionally used in the liquid crystal composition.

In certain embodiments, the at least one difunctional compound is in an amount ranging from 0.01 part by weight to 5 parts by weight based on 100 parts by weight of the liquid crystal composition. In certain embodiments, the at least one difunctional compound is in an amount ranging from 0.01 part by weight to 3 parts by weight based on 100 parts by weight of the liquid crystal composition. In certain embodiments, the at least one difunctional compound is in an amount ranging from 0.1 part by weight to 3 parts by weight based on 100 parts by weight of the liquid crystal composition.

In certain embodiments, the at least one monofunctional compound is in an amount ranging from 0.1 part by weight to 20 parts by weight based on 100 parts by weight of the liquid crystal composition. In certain embodiments, the at least one monofunctional compound is in an amount ranging from 1 part by weight to 15 parts by weight based on 100 parts by weight of the liquid crystal composition. In certain embodiments, the at least one monofunctional compound is in an amount ranging from 2 parts by weight to 10 parts by weight based on 100 parts by weight of the liquid crystal composition.

In addition to the at least one difunctional compound and the at least one monofunctional compound, the liquid crystal composition according to the disclosure may include other liquid crystal compound(s) having at least one acrylate group or at least one acrylated-derived group. Examples of such other liquid crystal compound(s) include, but are not limited to, a liquid crystal compound represented by Formula (I) and a liquid crystal compound represented by Formula (II),

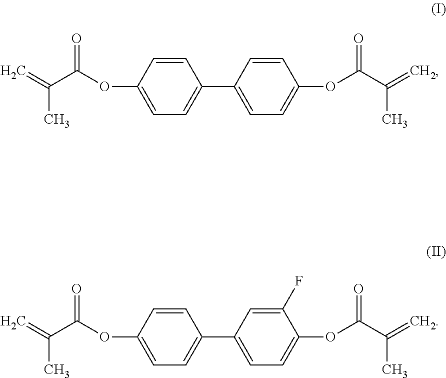 [SMILES: C=C(C)C(=O)Oc1ccc(-c2ccc(OC(=O)C(=C)C)cc2)cc1 ; C=C(C)C(=O)Oc1ccc(-c2ccc(OC(=O)C(=C)C)c(F)c2)cc1]

In certain embodiments, the liquid crystal composition according to the disclosure further includes a liquid crystal compound represented by Formula (5),

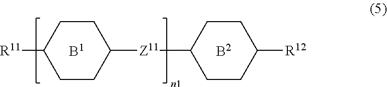

wherein

R¹¹ and R¹² each, independently of one another, represent hydrogen, halogen, a C₁-C₁₅ straight alkyl group, a C₃-C₁₅ branched alkyl group, a C₂-C₁₅ straight alkenyl group, or a C₃-C₁₅ branched alkenyl group, wherein each of the C₁-C₁₅ straight alkyl group, the C₃-C₁₅ branched alkyl group, the C₂-C₁₅ straight alkenyl group, and the C₃-C₁₅ branched alkenyl group is unsubstituted or substituted with at least one halogen atom, and at least one —CH₂— group in each of the C₁-C₁₅ straight alkyl group, the C₃-C₁₅ branched alkyl group, the C₂-C₁₅ straight alkenyl group, and the C₃-C₁₅ branched alkenyl group is optionally replaced with a —O— radical, with the proviso that when at least two of the —CH₂— groups are replaced with the —O— radicals, the —O— radicals are not bonded to each other directly;

B¹ and B² each, independently of one another, represent 1,4-phenylene, 1,4-cyclohexylene, benzofuran-2,5-diyl, 1,3-dioxane-2,5-diyl, tetrahydropyran-2,5-diyl, a divalent dioxa-bicyclo[2.2.2]octyl functional group, a divalenttrioxa-bicyclo[2.2.2]octylfunctionalgroup, or indane-2,5-diyl, wherein each of the 1,4-phenylene, the 1,4-cyclohexylene, the benzofuran-2,5-diyl, the 1,3-dioxane-2,5-diyl, and the tetrahydropyran-2,5-diyl is unsubstituted or substituted with at least one radical selected from the group consisting of halogen and a cyano group, and at least one —CH₂— group in each of the 1,4-phenylene, the 1,4-cyclohexylene, the benzofuran-2,5-diyl, the 1,3-dioxane-2,5-diyl, and the tetrahydropyran-2,5-diyl is optionally replaced with a second divalent radical selected from the group consisting of —O—, —N—, and —S—, with the proviso that when at least two of the —CH₂— groups are replaced with the second divalent radicals, the second divalent radicals are not bonded to each other directly;

Z¹¹ represents a single bond, a C₁-C₄ straight alkylene group, a C₃-C₄ branched alkylene group, a C₂-C₄ straight alkenylene group, a C₃-C₄ branched alkenylene group, a C₂-C₄ straight alkynylene group, or a C₄ branched alkynylene group, wherein each of the C₁-C₄ straight alkylene group, the C₃-C₄ branched alkylene group, the C₂-C₄ straight alkenylene group, the C₃-C₄ branched alkenylene group, the C₂-C₄ straight alkynylene group, and the C₄ branched alkynylene group is unsubstituted or substituted with at least one radical selected from the group consisting of halogen and a cyano group, and at least one —CH₂— group in each of the C₁-C₄ straight alkylene group, the C₃-C₄ branched alkylene group, the C₂-C₄ straight alkenylene group, the C₃-C₄ branched alkenylene group, the C₂-C₄ straight alkynylene group, and the C₄ branched alkynylene group is optionally replaced with a third divalent radical selected from the group consisting of —O— and —S—, with the proviso that when at least two of the —CH₂— groups are replaced with the third divalent radicals, the third divalent radicals are not bonded to each other directly; and

n1 is an integer ranging from 0 to 2, provided that when n1 is 2, two B¹s are the same or different and two Z¹¹s are the same or different.

In certain embodiments, the liquid crystal compound represented by Formula (5) is selected from the group consisting of a liquid crystal compound represented by Formula (5a) and a liquid crystal compound represented by Formula (5b),

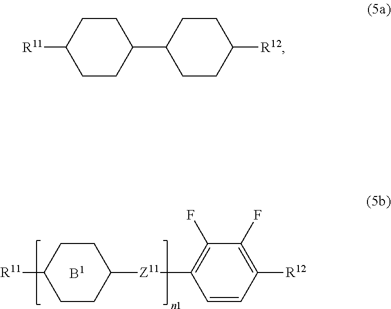

wherein

R¹¹, R¹², and Z¹¹ are as defined above for Formula (5);

B¹ represents 1,4-phenylene or 1,4-cyclohexylene, wherein each of the 1,4-phenylene and the 1,4-cyclohexylene is unsubstituted or substituted with at least one radical selected from the group consisting of halogen and a cyano group, and at least one —CH₂— group in each of the 1,4-phenylene and the 1,4-cyclohexylene is optionally replaced with the second divalent radical selected from the group consisting of —O—, —N—, and —S—, with the proviso that when at least two of the —CH₂— groups are replaced with the second divalent radicals, the second divalent radicals are not bonded to each other directly; and

n1 is 1 or 2.

The liquid crystal compound represented by Formula (5a) used in the following illustrated examples includes liquid crystal compounds represented by Formulae (5a-1), (5a-2), (5a-3), and (5a-4),

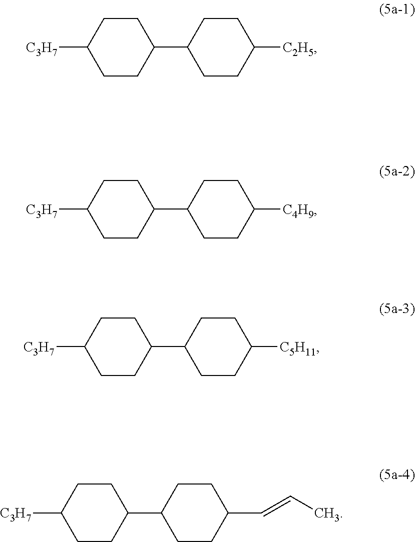

In certain embodiments, in Formula (5b), n1 is 1 and B¹ represents 1,4-cyclohexylene, i.e., the liquid crystal compound represented by Formula (5b) is a liquid crystal compound represented by:

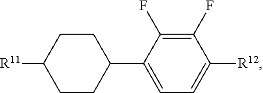

wherein R¹¹ and R¹² are as defined above.

In certain embodiments, in Formula (5b), n1 is 1 and B¹ represents 1,4-phenylene, i.e., the liquid crystal compound represented by Formula (5b) is a liquid crystal compound represented by:

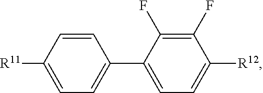

wherein R¹¹ and R¹² are as defined above.

In certain embodiments, in Formula (5b), n1 is 2 and the two B¹s represent 1,4-cyclohexylene and 1,4-phenylene, respectively, i.e., the liquid crystal compound represented by Formula (5b) is a liquid crystal compound represented by:

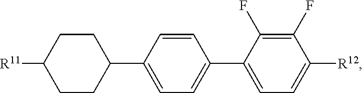

wherein R¹¹ and R¹² are as defined above.

In certain embodiments, in Formula (5b), n1 is 2 and both B¹s represent 1,4-cyclohexylene, i.e., the liquid crystal compound represented by Formula (5b) is a liquid crystal compound represented by:

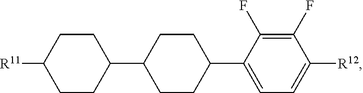

wherein R¹¹ and R¹² are as defined above.

The liquid crystal compound represented by Formula (5b) used in the following illustrated examples includes liquid crystal compounds represented by Formulae (5b-1), (5b-2), (5b-3), and (5b-4),

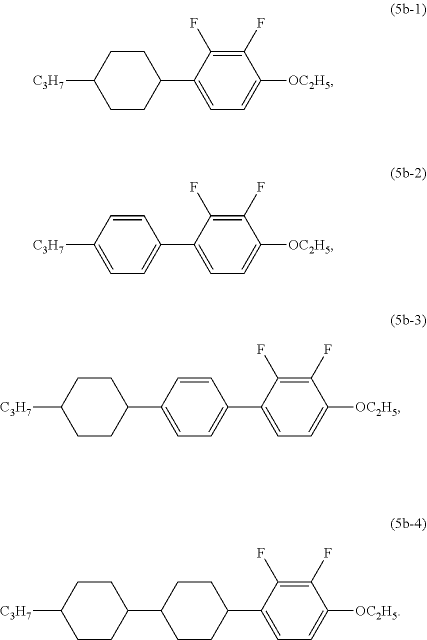

In certain embodiments, the compound represented by Formula (5) is in an amount ranging from 20 parts by weight to 98 parts by weight based on 100 parts by weight of the liquid crystal composition. In certain embodiments, the compound represented by Formula (5) is in an amount ranging from 50 parts by weight to 98 parts by weight based on 100 parts by weight of the liquid crystal composition.

In addition, the liquid crystal composition according to the disclosure may optionally include any liquid crystal compounds having various properties.

### Application:

The liquid crystal composition according to the disclosure can be used to make a liquid crystal layer of a liquid crystal display, especially a liquid crystal display without an alignment film.

Examples of the disclosure will be described hereinafter. It is to be understood that these examples are exemplary and explanatory and should not be construed as a limitation to the disclosure.

### Synthesis Example 1: Preparation of a Difunctional Compound of Formula (1a-2)

The compound of Formula (1a-2) was synthesized according to the reaction scheme below.

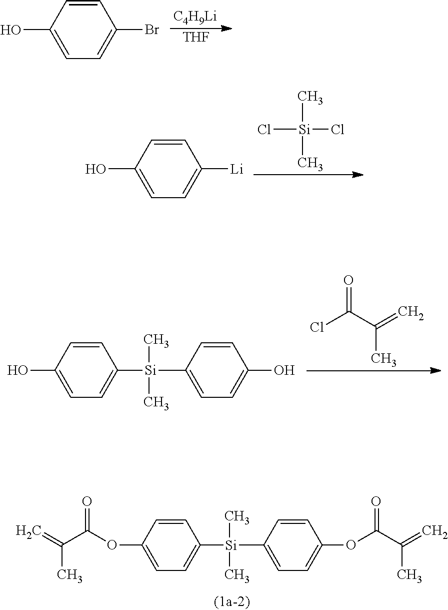

4-bromophenol (0.1 mol) and tetrahydrofuran (100 ml) were added into a reaction flask. Then, N-butyl lithium (0.4 mol) was slowly added into the reaction flask at −70° C. under a nitrogen atmosphere, followed by stirring at −70° C. for 2 hours and further at −10° C. for 2 hours. After that, dimethyldichlorosilane (0.1 mol) was slowly added into the reaction flask at −70° C. under a nitrogen atmosphere, followed by stirring at −70° C. for 2 hours and further at room temperature for 10 hours. Then, triethylamine (0.2 mol) was added into the reaction flask, followed by stirring at room temperature for 10 minutes. Subsequently, 2-methylacryloyl chloride (0.2 mol) was added into the reaction flask, followed by stirring at room temperature for 2 hours to obtain a reaction mixture. The reaction mixture was extracted with ethyl acetate and a saline solution, followed by collecting an organic layer. The organic layer was concentrated and purified via column chromatography using a mixture of ethyl acetate and hexane in a volume ratio of 1:9 as an eluent to obtain the difunctional compound of Formula (1a-2) as a liquid. The molecular weight of the difunctional compound was determined using a gas chromatography-mass spectrometer (GC-MS) and is shown to be m/z=380 [M]⁺.

### Examples 1 to 7 and Comparative Examples 1 and 2: Preparation of Liquid Crystal Compositions

Each of the liquid crystal compositions of Examples 1 to 7 and Comparative Examples 1 and 2 was prepared by homogeneously mixing the compounds and the amounts thereof shown in Table 1 to a premix, followed by heating the premix to a clearing point (Tₙᵢ) and then cooling to room temperature.

TABLE 1

| | | | | | | | | | Comparative | |
|---|---|---|---|---|---|---|---|---|---|---|
| Amounts | | Examples | | | | | | | Examples | |
| (part by weight) | | 1 | 2 | 3 | 4 | 5 | 6 | 7 | 1 | 2 |
| Difunctional | 1a-1 | 0.18 | | | | | | | | |
| compounds | 1a-2 | | | | | | 0.39 | 2.04 | | |
| | 1a-3 | | 0.19 | | | | | | | |
| | 1a-4 | | | | | | | | | |
| | 1a-5 | | | | | | | | | |
| | 2a-1 | | | | 0.29 | | | | | |
| | 2a-2 | | | 0.58 | | 0.90 | | | | |
| Monofunctional | 3a-1 | 7.38 | | 2.90 | | | | | | |
| compounds | 3a-2 | | 4.74 | | | | | 5.51 | 2.91 | |
| | 3a-3 | | | | 2.90 | | 0.98 | | | |
| | 4a-3 | | | | | 9.01 | | | | |

| | | | | | | | | | |
|---|---|---|---|---|---|---|---|---|---|
| I | 0.18 | | | | | 0.78 | 0.66 | | 0.30 |
| II | | 0.28 | | | | | | | |
| 5a-1 | 9.23 | 9.48 | 9.65 | 9.68 | 9.01 | 9.78 | 9.18 | 9.71 | 9.97 |
| 5a-2 | 4.61 | 4.74 | 4.83 | 4.84 | 4.50 | 4.89 | 4.59 | 4.85 | 4.99 |
| 5a-3 | 11.07 | 11.37 | 11.58 | 11.62 | 10.81 | 11.74 | 11.02 | 11.65 | 11.96 |
| 5a-4 | 12.92 | 13.27 | 13.51 | 13.55 | 12.61 | 13.70 | 12.85 | 13.59 | 13.96 |
| 5b-1 | 9.23 | 9.48 | 9.65 | 9.68 | 9.01 | 9.78 | 9.18 | 9.71 | 9.97 |
| 5b-2 | 17.53 | 18.01 | 18.34 | 18.39 | 17.12 | 18.59 | 17.44 | 18.45 | 18.94 |
| 5b-3 | 13.84 | 14.22 | 14.48 | 14.52 | 13.51 | 14.68 | 13.77 | 14.56 | 14.96 |
| 5b-4 | 13.84 | 14.22 | 14.48 | 14.52 | 13.51 | 14.68 | 13.77 | 14.56 | 14.96 |

### Application Examples 1 to 7 and Comparative Application Examples 1 and 2: Preparation of Liquid Crystal Displays

Each of the liquid crystal compositions of Examples 1 to 7 and Comparative Examples 1 and 2 was injected into a space between two indium tin oxide-coated substrates (ITO-coated substrates) with a cell gap of 3.5 μm, followed by sealing according to a common method for preparing a liquid crystal cell. A DC voltage of 12 V was applied to the liquid crystal cell thus prepared while irradiating with ultraviolet light (peak wavelength: 313 nm) for curing to obtain a liquid crystal display.

### Measurements:

Each of the liquid crystal displays of Application Examples 1 to 7 and Comparative Application Examples 1 and 2 was measured for vertical alignment thereof according the method below. Furthermore, each of the liquid crystal displays of Application Examples 2, 3, and 6, and Comparative Application Examples 1 and 2 was measured for voltage holding ratio and pretilt angle thereof according to the methods below. The results are shown in Tables 2 and 3 below.

### 1. Vertical Alignment:

The liquid crystal display was disposed on a polarizing microscope equipped with a polarizer and an analyzer which were arranged orthogonally to one another. The liquid crystal display was irradiated using a light source disposed below the polarizing microscope, and the presence or absence of light leakage was observed to determine the vertical alignment of the liquid crystal display. Evaluation was made according to the standards below.
◯: light leakage was not observed on the whole liquid crystal display
Δ: light leakage was observed on part(s) of the liquid crystal display
x: light leakage was observed on the whole liquid crystal display

### 2. Voltage Holding Ratio:

A DC voltage (charge voltage: 5V, operating frequency: 0.6 Hz, and pulse width: 60 psec) was applied to the liquid crystal display at an environmental temperature of 60° C. to measure the voltage holding ratio thereof. A minimum current and an extremely low leakage voltage of the liquid crystal display were measured using a liquid crystal measuring instrument (Model: ALCT-IV1, Manufacturer: INSTEC Corporation) to determine the voltage holding ratio at a voltage of 5V.

### 3. Pretilt Angle:

The pretilt angle of liquid crystal molecules in a liquid crystal cell was measured via a crystal rotation method. Specifically, the liquid crystal cell was rotated to change an incident angle of a laser light. The change in phase retardation of the laser light transmitted through the liquid crystal cell was used to determine the pretilt angle of the liquid crystal molecules.

TABLE 2

| | | | | | | | | Comparative | |
|---|---|---|---|---|---|---|---|---|---|
| | | | | | | | | Application | |
| | Application Examples | | | | | | | Examples | |
| Measurement | 1 | 2 | 3 | 4 | 5 | 6 | 7 | 1 | 2 |
| Vertical | ◯ | ◯ | ◯ | Δ | ◯ | Δ | ◯ | X | X |
| alignment | | | | | | | | | |

As shown in Table 2, all of the liquid crystal displays of Application Examples 1 to 7 have satisfactory vertical alignment, demonstrating that the liquid crystal composition according to the disclosure, which includes the specific difunctional compound and the specific monofunctional compound, exhibits satisfactory vertical alignment. Contrarily, the liquid crystal displays of Comparative Application Examples 1 and 2, in which the liquid crystal compositions only include the monofunctional compound or do not include the difunctional compound and the monofunctional compound, have inferior vertical alignment.

TABLE 3

| | | | | Comparative | |
|---|---|---|---|---|---|
| | | | | Application | |
| | Application Examples | | | Examples | |
| Measurements | 2 | 3 | 6 | 1 | 2 |
| Pretilt angle(°) | 90.08 | 90.27 | — | — | — |
| Voltage holding ratio (%) | 96.70 | 80.69 | 92.63 | 69.29 | 37.14 |

As shown in Table 3, each of the liquid crystal displays of Application Examples 2, 3, and 6 has a voltage holding ratio that is significantly higher than that of each of the liquid crystal displays of Comparative Application Examples 1 and 2, demonstrating that the liquid crystal composition according to the disclosure can be used for preparing a liquid crystal display having a superior voltage holding ratio. In addition, each of the liquid crystal displays of Application Examples 2 and 3 has a satisfactory pretilt angle to satisfy subsequent requirements.

In view of the aforesaid, the liquid crystal composition according to the disclosure, which includes the specific difunctional compound and the specific monofunctional compound, exhibits satisfactory vertical alignment. In addition, the liquid crystal display prepared using the liquid crystal composition according to the disclosure exhibits a superior voltage holding ratio.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, FIGURE, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A liquid crystal composition, comprising:
at least one difunctional compound selected from the group consisting of difunctional compounds represented by Formulae (1) and (2), and
at least one monofunctional compound selected from the group consisting of monofunctional compounds represented by Formulae (3) and (4), 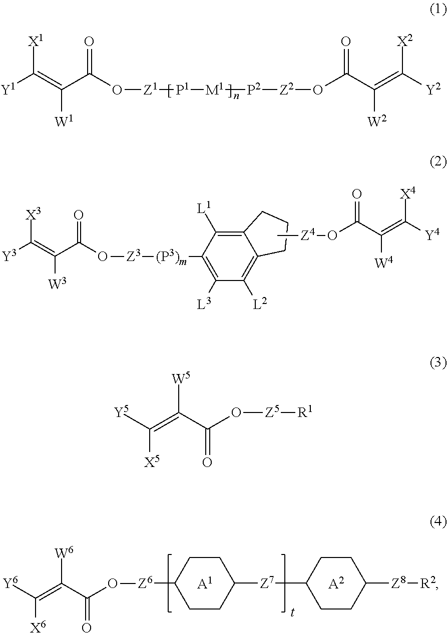
wherein
X¹ to X⁶, Y¹ to Y⁶, and W¹ to W⁶ are each, independently of one another, selected from the group consisting of hydrogen, hydroxyl, halogen, a C₁-C₁₅ straight alkyl group, a C₃-C₁₅ branched alkyl group, a C₂-C₁₅ straight alkenyl group, a C₃-C₁₅ branched alkenyl group, a C₂-C₁₅ straight alkynyl group, and a C₄-C₁₅ branched alkynyl group, wherein each of said C₁-C₁₅ straight alkyl group, said C₃-C₁₅ branched alkyl group, said C₂-C₁₅ straight alkenyl group, said C₃-C₁₅ branched alkenyl group, said C₂-C₁₅ straight alkynyl group, and said C₄-C₁₅ branched alkynyl group is unsubstituted or substituted with at least one radical selected from the group consisting of halogen and hydroxyl, and at least one —CH₂— group in each of said C₁-C₁₅ straight alkyl group, said C₃-C₁₅ branched alkyl group, said C₂-C₁₅ straight alkenyl group, said C₃-C₁₅ branched alkenyl group, said C₂-C₁₅ straight alkynyl group, and said C₄-C₁₅ branched alkynyl group is optionally replaced with a ring radical;
Z¹ to Z⁴ are each, independently of one another, selected from the group consisting of a single bond and a spacer group;
Z⁵ and Z⁶ are each, independently of one another, selected from the group consisting of a single bond, a C₁-C₁₅ straight alkylene group, a C₃-C₁₅ branched alkylene group, a C₂-C₁₅ straight alkenylene group, and a C₃-C₁₅ branched alkenylene group, wherein each of said C₁-C₁₅ straight alkylene group, said C₃-C₁₅ branched alkylene group, said C₂-C₁₅ straight alkenylene group, and said C₃-C₁₅ branched alkenylene group is unsubstituted or substituted with at least one halogen atom, and at least one —CH₂— group in each of said C₁-C₁₅ straight alkylene group, said C₃-C₁₅ branched alkylene group, said C₂-C₁₅ straight alkenylene group, and said C₃-C₁₅ branched alkenylene group is optionally replaced with a first divalent radical selected from the group consisting of —O—, —CO—, —COO—, and —OCO—, with the proviso that when at least two of said —CH₂— groups are replaced with said first divalent radicals, said first divalent radicals are not bonded to each other directly;
Z⁷ and Z⁸ are each, independently of one another, selected from the group consisting of a single bond, —COO—, —OCO—, —C≡C—, a C₁-C₁₂ straight alkylene group, a C₃-C₁₂ branched alkylene group, a C₂-C₁₂ straight alkenylene group, and a C₃-C₁₂ branched alkenylene group, wherein each of said C₁-C₁₂ straight alkylene group, said C₃-C₁₂ branched alkylene group, said C₂-C₁₂ straight alkenylene group, and said C₃-C₁₂ branched alkenylene group is unsubstituted or substituted with at least one halogen atom, and at least one —CH₂— group in each of said C₁-C₁₂ straight alkylene group, said C₃-C₁₂ branched alkylene group, said C₂-C₁₂ straight alkenylene group, and said C₃-C₁₂ branched alkenylene group is optionally replaced with a —O— radical, with the proviso that when at least two of said —CH₂— groups are replaced with said —O— radicals, said —O— radicals are not bonded to each other directly;
P¹ to P³, A¹, and A² are each, independently of one another, selected from the group consisting of 1,4-phenylene, 1,4-cyclohexylene, 1,4-cyclohexenylene, pyridine-2,5-diyl, pyrimidine-2,5-diyl, 1,3-dioxane-2,5-diyl, benzofuran-2,5-diyl, tetrahydropyran-2,5-diyl, a divalent trioxa-bicyclo[2.2.2]octyl functional group, a divalent dioxa-bicyclo[2.2.2]octyl functional group, and indane-2,5-diyl, each of which is unsubstituted or substituted with at least one radical selected from the group consisting of a C₁-C₈ alkyl group, a C₁-C₈ haloalkyl group, a C₁-C₈ alkoxyl group, halogen, a cyano group, and a nitro group;
M¹ is selected from the group consisting of —CH₂—, —C(CH₃)₂—, —C(CF₃)₂—, —SiH₂—, —Si(CH₃)₂—, and —Si(CF₃)₂—;
L¹ to L³ are each, independently of one another, selected from the group consisting of hydrogen, F, Cl, CN, a C₁-C₁₂ straight alkyl group, a C₃-C₁₂ branched alkyl group, a C₂-C₁₂ straight alkenyl group, a C₃-C₁₂ branched alkenyl group, a C₂-C₁₂ straight alkynyl group, and a C₄-C₁₂ branched alkynyl group, wherein each of said C₁-C₁₂ straight alkyl group, said C₃-C₁₂ branched alkyl group, said C₂-C₁₂ straight alkenyl group, said C₃-C₁₂ branched alkenyl group, said C₂-C₁₂ straight alkynyl group, and said C₄-C₁₂ branched alkynyl group is unsubstituted or substituted with at least one halogen atom, and at least one —CH₂— group in each of said C₁-C₁₂ straight alkyl group, said C₃-C₁₂ branched alkyl group, said C₂-C₁₂ straight alkenyl group, said C₃-C₁₂ branched alkenyl group, said C₂-C₁₂ straight alkynyl group, and said C₄-C₁₂ branched alkynyl group is optionally replaced with said first divalent radical selected from the group consisting of —O—, —CO—, —COO—, and —OCO—, with the proviso that when at least two of said —CH₂— groups are replaced with said first divalent radicals, said first divalent radicals are not bonded to each other directly;
R¹ and R² are each, independently of one another, selected from the group consisting of hydrogen, a C₁-C₇₀ straight alkyl group, a C₃-C₇₀ branched alkyl group, a C₂-C₇₀ straight alkenyl group, a C₃-C₇₀ branched alkenyl group, a C₂-C₇₀ straight alkynyl group, and a C₄-C₇₀ branched alkynyl group, wherein each of said C₁-C₇₀ straight alkyl group, said C₃-C₇₀ branched alkyl group, said C₂-C₇₀ straight alkenyl group, said C₃-C₇₀ branched alkenyl group, said C₂-C₇₀ straight alkynyl group, and said C₄-C₇₀ branched alkynyl group is unsubstituted or substituted with at least one halogen atom, and at least one —CH₂— group in each of said C₁-C₇₀ straight alkyl group, said C₃-C₇₀ branched alkyl group, said C₂-C₇₀ straight alkenyl group, said C₃-C₇₀ branched alkenyl group, said C₂-C₇₀ straight alkynyl group, and said C₄-C₇₀ branched alkynyl group is optionally replaced with said first divalent radical selected from the group consisting of —O—, —CO—, —COO—, and —OCO—, with the proviso that when at least two of said —CH₂— groups are replaced with said first divalent radicals, said first divalent radicals are not bonded to each other directly;
n is an integer ranging from 1 to 3, provided that when n is 2 or 3, a plurality of P¹s are the same or different and a plurality of M¹s are the same or different;
m is an integer ranging from 0 to 3, provided that when m is 2 or 3, a plurality of Pas are the same or different; and
t is an integer ranging from 1 to 2, provided that when t is 2, two A¹s are the same or different and two Z⁷s are the same or different.

2. The liquid crystal composition according to claim 1, wherein said difunctional compound represented by Formula (1) is a difunctional compound represented by Formula (1a), 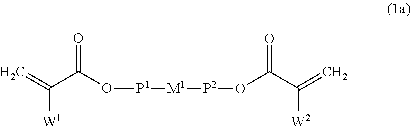
wherein
P¹ and P² are each, independently of one another, selected from the group consisting of 1,4-phenylene, 1,4-cyclohexylene, 3-fluoro-1,4-phenylene, 3,5-difluoro-1,4-phenylene, 2,3-difluoro-1,4-phenylene, 3-methyl-1,4-phenylene, 3,5-dimethyl-1,4-phenylene, and 2,3-dimethyl-1,4-phenylene; and
M¹, W¹, and W² are as defined in claim 1.

3. The liquid crystal composition according to claim 1, wherein said difunctional compound represented by Formula (2) is a difunctional compound represented by Formula (2a), 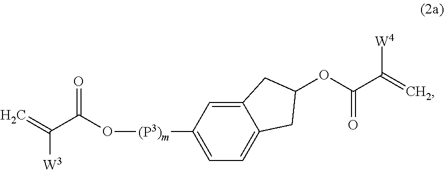
wherein
P³ is selected from the group consisting of 1,4-phenylene, 1,4-cyclohexylene, 3-fluoro-1,4-phenylene, 3,5-difluoro-1,4-phenylene, 2,3-difluoro-1,4-phenylene, 3-methyl-1,4-phenylene, 3,5-dimethyl-1,4-phenylene, and 2,3-dimethyl-1,4-phenylene; and
m, W³, and W⁴ are as defined in claim 1.

4. The liquid crystal composition according to claim 1, wherein said monofunctional compound represented by Formula (3) is a monofunctional compound represented by Formula (3a), 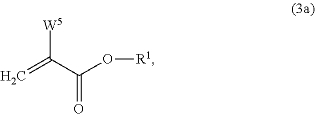
wherein
R¹ is selected from the group consisting of a C₁-C₃₀ straight alkyl group, a C₃-C₃₀ branched alkyl group, a C₂-C₃₀ straight alkenyl group, and a C₃-C₃₀ branched alkenyl group; and
W⁵ is as defined in claim 1.

5. The liquid crystal composition according to claim 1, wherein said monofunctional compound represented by Formula (4) is a monofunctional compound represented by Formula (4a), 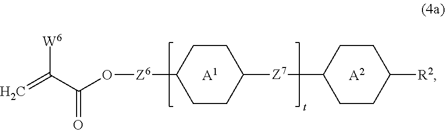
wherein
A¹ and A² are each, independently of one another, selected from the group consisting of 1,4-phenylene, 1,4-cyclohexylene, 3-fluoro-1,4-phenylene, 3,5-difluoro-1,4-phenylene, 2,3-difluoro-1,4-phenylene, 3-methyl-1,4-phenylene, 3,5-dimethyl-1,4-phenylene, and 2,3-dimethyl-1,4-phenylene;
Z⁷ is selected from the group consisting of a single bond, —COO—, —OCO—, —C≡C—, a C₁₋₆ straight alkylene group, and a C₃-C₆ branched alkylene group; and
W⁶, Z⁶, and R² are as defined in claim 1.

6. The liquid crystal composition according to claim 1, wherein said at least one difunctional compound is in an amount ranging from 0.01 part by weight to 5 parts by weight and said at least one monofunctional compound is in an amount ranging from 0.1 part by weight to 20 parts by weight based on 100 parts by weight of said liquid crystal composition.

7. The liquid crystal composition according to claim 1, further comprising a liquid crystal compound represented by Formula (5), 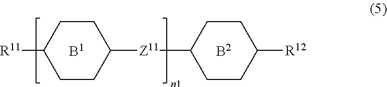
wherein
R¹¹ and R¹² are each, independently of one another, selected from the group consisting of hydrogen, halogen, a C₁-C₁₅ straight alkyl group, a C₃-C₁₅ branched alkyl group, a C₂-C₁₅ straight alkenyl group, and a C₃-C₁₅ branched alkenyl group, wherein each of said C₁-C₁₅ straight alkyl group, said C₃-C₁₅ branched alkyl group, said C₂-C₁₅ straight alkenyl group, and said C₃-C₁₅ branched alkenyl group is unsubstituted or substituted with at least one halogen atom, and at least one —CH₂— group in each of said C₁-C₁₅ straight alkyl group, said C₃-C₁₅ branched alkyl group, said C₂-C₁₅ straight alkenyl group, and said C₃-C₁₅ branched alkenyl group is optionally replaced with a —O— radical, with the proviso that when at least two of said —CH₂— groups are replaced with said —O— radicals, said —O— radicals are not bonded to each other directly;
B¹ and B² are each, independently of one another, selected from the group consisting of 1,4-phenylene, 1,4-cyclohexylene, benzofuran-2,5-diyl, 1,3-dioxane-2,5-diyl, tetrahydropyran-2,5-diyl, a divalent dioxa-bicyclo[2.2.2]octyl functional group, a divalent trioxa-bicyclo[2.2.2]octyl functional group, and indane-2,5-diyl, wherein each of said 1,4-phenylene, said 1,4-cyclohexylene, said benzofuran-2,5-diyl, said 1,3-dioxane-2,5-diyl, and said tetrahydropyran-2,5-diyl is unsubstituted or substituted with at least one radical selected from the group consisting of halogen and a cyano group, and at least one —CH₂— group in each of said 1,4-phenylene, said 1,4-cyclohexylene, said benzofuran-2,5-diyl, said 1,3-dioxane-2,5-diyl, and said tetrahydropyran-2,5-diyl is optionally replaced with a second divalent radical selected from the group consisting of —O—, —N—, and —S—, with the proviso that when at least two of said —CH₂— groups are replaced with said second divalent radicals, said second divalent radicals are not bonded to each other directly;
Z¹¹ is selected from the group consisting of a single bond, a C₁-C₄ straight alkylene group, a C₃-C₄ branched alkylene group, a C₂-C₄ straight alkenylene group, a C₃-C₄ branched alkenylene group, a C₂-C₄ straight alkynylene group, and a C₄ branched alkynylene group, wherein each of said C₁-C₄ straight alkylene group, said C₃-C₄ branched alkylene group, said C₂-C₄ straight alkenylene group, said C₃-C₄ branched alkenylene group, said C₂-C₄ straight alkynylene group, and said C₄ branched alkynylene group is unsubstituted or substituted with at least one radical selected from the group consisting of halogen and a cyano group, and at least one —CH₂— group in each of said C₁-C₄ straight alkylene group, said C₃-C₄ branched alkylene group, said C₂-C₄ straight alkenylene group, said C₃-C₄ branched alkenylene group, said C₂-C₄ straight alkynylene group, and said C₄ branched alkynylene group is optionally replaced with a third divalent radical selected from the group consisting of —O— and —S—, with the proviso that when at least two of said —CH₂— groups are replaced with said third divalent radicals, said third divalent radicals are not bonded to each other directly; and
n1 is an integer ranging from 0 to 2, provided that when n1 is 2, two B¹s are the same or different and two Z¹¹s are the same or different.

8. The liquid crystal composition according to claim 7, wherein said liquid crystal compound represented by Formula (5) is selected from the group consisting of a liquid crystal compound represented by Formula (5a) and a liquid crystal compound represented by Formula (5b), 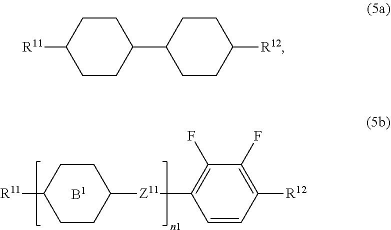
wherein
R¹¹, R¹², and Z¹¹ are as defined in claim 7;
B¹ is selected from the group consisting of 1,4-phenylene and 1,4-cyclohexylene, wherein each of said 1,4-phenylene and said 1,4-cyclohexylene is unsubstituted or substituted with at least one radical selected from the group consisting of halogen and a cyano group, and at least one —CH₂— group in each of said 1,4-phenylene and said 1,4-cyclohexylene is optionally replaced with said second divalent radical selected from the group consisting of —O—, —N—, and —S—, with the proviso that when at least two of said —CH₂— groups are replaced with said second divalent radicals, said second divalent radicals are not bonded to each other directly; and
n1 is an integer ranging from 1 to 2.

9. The liquid crystal composition according to claim 7, wherein said liquid crystal compound represented by Formula (5) is in an amount ranging from 20 parts by weight to 98 parts by weight based on 100 parts by weight of said liquid crystal composition.

10. A liquid crystal display, comprising the liquid crystal composition according to claim 1.
